(19) United States
(12) Patent Application Publication
(10) Pub. No.: US 2025/0296593 A1
(43) Pub. Date: Sep. 25, 2025

(54) VEHICLE SAFETY SYSTEM FOR ALERTING A DRIVER OF HAZARDOUS SITUATIONS

(71) Applicant: Joseph Michael Dillon, Columbus, MS (US)

(72) Inventor: Joseph Michael Dillon, Columbus, MS (US)

(21) Appl. No.: 19/084,680

(22) Filed: Mar. 19, 2025

Related U.S. Application Data
(60) Provisional application No. 63/568,135, filed on Mar. 21, 2024.

(51) Int. Cl. B60W 50/14; B60K 35/28; H04W 4/90

(52) U.S. Cl. CPC B60W 50/14; B60K 35/28; H04W 4/90; B60W 2420/403; B60W 2420/54

(57) ABSTRACT

A vehicle safety system for alerting a driver and vehicle occupants of hazardous situations is disclosed. The vehicle safety system installs in a first vehicle. The vehicle safety system includes image capturing units, and sound detection sensors positioned at multiple locations at exterior or interior of the first vehicle. The vehicle safety system is configured to detect light and sound produced from a second vehicle such as an emergency or hazardous vehicle, school bus, train, etc. The vehicle safety system provides advanced warning of the second vehicle to a driver and occupants of the first vehicle through programmed vehicle actions and visual and audible communications. The vehicle safety system helps the driver of the first vehicle to comply with regulations requiring yielding to emergency vehicles and stopping for school buses/trains, and enhances safety of the driver and/or passengers of the first vehicle and protects those affected by the second vehicle.

### CROSS-REFERENCE TO RELATED APPLICATIONS

The present application claims the benefit of U.S. Provisional Application No. 63/568,135, filed Mar. 21, 2024; all of which is incorporated herein in its entirety and referenced thereto.

### BACKGROUND OF THE INVENTION

### Field of the Invention

The present invention generally relates to a vehicle safety system. More particularly, the present invention relates to a vehicle safety system for activating programmed actions of the vehicle while also alerting a driver and vehicle occupants of hazardous situations.

### Description of the Prior Art

In the 1700s, Dalmatians were trained to go ahead of horse-drawn fire engines to clear the path of emergency responders. The Dalmatians acted as a visual notification by running ahead of the fire engine and sprinting from side to side of the roadway. The Dalmatians also offered an audio notification with their non-stop barking. Their presence helped clear the path for these “first” first responders. Today, an emergency vehicle is generally defined as a specialized vehicle used by emergency services to respond to urgent situations and provide required assistance. An example of the emergency vehicle includes, but not limited to, an ambulance, fire truck, police vehicle, rescue vehicle, tow truck, etc. Whenever the emergency vehicle responds to an emergency, the emergency vehicle moves at a high speed while flashing lights and broadcasting a siren. Generally, non-emergency vehicles i.e., civilian vehicles and/or commercial vehicles are required to move over, slow down, stop, and/or otherwise give way and provide the emergency vehicle with safe passage. In some situations, drivers of the non-emergency vehicles fail to notice the emergency vehicle due to driver inattention, poor visibility, ambient noise, etc. Failure to notice the emergency vehicle may result in slowing down the response to the emergency or may lead to a traffic incident.

In order to overcome the above problem, several solutions have been disclosed in the past. One such solution is disclosed in a U.S. Pat. No. 8,605,948, entitled “Driver assistance system for monitoring driving safety and corresponding method for detecting and evaluating a vehicle movement” (“the '948 patent”). The '948 patent discloses a driver assistance system for monitoring driving safety has a mobile electronic unit including a video sensor, a computer unit for image data processing, and an acoustic output unit, which detects the immediate surroundings of the vehicle from the data of the video sensor and outputs a warning or information via an output unit when the computer unit detects a dangerous situation. The mobile electronic unit detects noises within the vehicle or from the outside via an acoustic input unit, and incorporates the information in the assessment of driving safety.

Another example is disclosed in United States Publication No. 20230264713, entitled “System and method for managing environmental conditions for an autonomous vehicle” (“the '713 Publication”). The '713 Publication discloses systems and methods for managing environmental conditions for an autonomous vehicle. In one aspect, an autonomous vehicle includes a perception sensor configured to generate perception data indicative of a condition of the environment, a network communication transceiver configured to communicate with an oversight system and an external weather condition source, a non-transitory computer readable medium, and a processor. The processor is configured to: receive the perception data from the at least one perception sensor, receive an indication of current weather conditions from the external weather condition source, determine a current environmental condition severity level from a plurality of severity levels based on the perception data and the indication of current weather conditions, modify one or more driving parameters that that govern a range of actions that can be autonomously executed by the autonomous vehicle, and navigate the autonomous vehicle based on the modified driving parameters.

Another example is disclosed in United States Publication No. 20220048529, entitled “System and method for providing in-vehicle emergency vehicle detection and positional alerts” (“the '529 Publication”). The '529 Publication discloses system for providing in-vehicle emergency vehicle detection and positional alerts, including: a camera configured to obtain an image of surroundings of an ego vehicle; an emergency vehicle recognition and localization module operable for segmenting an emergency vehicle from the image of the surroundings in order to detect and locate the emergency vehicle relative to the ego vehicle; a microphone configured to obtain an auditory signal from the surroundings of the ego vehicle; a siren detection and directional positioning module operable for discriminating an emergency vehicle siren from the auditory signal from the surroundings in order to detect and locate the emergency vehicle relative to the ego vehicle; and one or more of a visual alert, an audible alert, and a haptic alert operable for alerting a driver of the ego vehicle to a presence and the location of the emergency vehicle.

Although the above discussed disclosures are useful, they still have problems and present incomplete solution. Therefore, there is a need in the art to provide an improved vehicle safety system for alerting a driver of hazardous situations.

### SUMMARY OF THE INVENTION

It is one of the main objects of the present invention to provide a vehicle safety system that avoids the drawbacks of the prior art. The present invention uses not only a preferred method, but incorporates vehicle actions, including but not limited to: turn off audio systems, lower windows to allow audio to reach the driver and occupants, disable cruise control to begin to slow the vehicle, flash the interior lights to alert occupants, provide a visual and sound notification of the hazard including the perceived direction of the hazard. Visual and audible analysis is incorporated to determine location including change in image size, quality, brightness, location and changes in sound levels, speed, Doppler effects and other readily available techniques.

It is another object of the present invention to provide a vehicle safety system for alerting a driver of hazardous situations including, but not limited to, emergency vehicles, school buses, trains, wreckers, and stranded motorists.

It is another object of the present invention to take actions to “unseal” the quiet, secluded passenger cabin of the vehicle that may simply be very quiet or filled with loud music or conversation.

In order to overcome the limitations here stated, the present invention provides a vehicle safety system for alerting a driver of hazardous situations. The hazardous situations include, but not limited to, presence of an emergency vehicle, school bus, train, etc.

Not all hazardous situations involve only emergency vehicles. Examples of situations requiring driver intervention from the equipped vehicle include stranded vehicles on the side of the roadway with only hazard flashers activated, wreckers assisting motorists, an approaching train entering a crossing with malfunctioning crossing arms and signals or working signals, a runaway truck or vehicle continuously sounding their vehicle's horn to clear the way, an emergency vehicle approaching an intersection or from the rear or front with emergency lights or sirens or both, a private vehicle approaching an intersection or from the front or rear sounding their horn for urgency, the sound of screeching brakes or a vehicle crash near the equipped vehicle, the sound of gunshots, and the sound of extremely loud music from another car that may be distracting that driver. The hazardous vehicle notification could be a law enforcement officer. The vehicle safety system installs in a first vehicle. The vehicle safety system includes image capturing units, and sound detection sensors positioned at multiple locations at the exterior or interior of the first vehicle. The vehicle safety system is configured to detect and learn light colors and patterns and sound produced from a second vehicle such as the emergency vehicle, school bus, train etc. The vehicle safety system continuously learns light and sound patterns and with feedback from system designers and vehicle operators, upon completion of their journey or activity, and the system becomes smarter and more responsive. In addition, learning activities are shared with other units throughout geographical areas for group learning and programming. The vehicle safety system can be used to reduce annoyance notifications and allow drivers to select the level of notification or action to be taken by the vehicle. The vehicle safety system provides advanced warning of the second vehicle to a driver of the first vehicle. In addition, physical changes in the second vehicle allow the driver and all occupants to determine the exact emergency need.

In one aspect, the vehicle safety system displays text warnings or shows video/images of the second vehicle e.g., emergency vehicle/school bus/train to draw attention of the driver of the first vehicle. Further, the vehicle safety system provides audible alerts to make the driver and passenger of the first vehicle aware of the danger/presence of the emergency vehicle/school bus/train. The system will also look for stopped vehicles parked on the side or in a roadway and notify the driver of the hazard.

In some aspects, the vehicle safety system operates in conjunction with an in-vehicle control system to lower and/or turn off an entertainment (audio/video) system of the first vehicle to allow the driver to hear emergency sounds.

In some aspects, the vehicle safety system operates in conjunction with the in-vehicle control system to operate one or more windows on the first vehicle to the desired position/height to allow the driver and/or passenger to hear sounds from the second vehicle.

In some aspects, the interior lights of the vehicle flash to notify occupants of the danger.

In some aspects, the cruise control, if engaged, is turned off allowing the vehicle to coast and slow down.

In some aspects, the vehicles heating and cooling system is turned off to eliminate the sound of the vehicle's fan from interfering with the driver and occupants' awareness of the situation.

In some aspects, a visual indicator with best interpretation of the vehicle's location relating to the hazard is displayed inside the vehicle along with an audible voice calling out the same information.

In one advantageous feature of the present invention, the vehicle safety system provides visual and audio alerts indicating the location of the emergency vehicle and/or course of action responsive to the emergency vehicle. This helps the driver to move away from the emergency vehicle in time and avoid slowing down the response to the emergency or leading to a traffic incident.

In another advantageous feature of the present invention, the vehicle safety system helps the driver of the first vehicle to comply with regulations requiring yielding to emergency vehicles and stopping for school buses/trains, and enhances the safety of the driver and/or occupants of the first vehicle.

These and other objects of the present invention will be apparent from review of the following specification and the accompanying drawings.

### BRIEF DESCRIPTION OF THE DRAWINGS

FIG. 1 illustrates an environment of a vehicle safety system, in accordance with one embodiment of the present invention.

FIG. 2 illustrates a block diagram of the vehicle safety system, in accordance with one embodiment of the present invention.

FIG. 3 illustrates a block diagram of a server, in accordance with one embodiment of the present invention.

FIG. 4 illustrates a method of alerting a driver of hazardous situations, in accordance with one embodiment of the present invention.

### DETAILED DESCRIPTION OF THE PREFERRED EMBODIMENT

The detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed extracting surface composition for a vehicle safety system. However, it will be apparent to those skilled in the art that the presently disclosed invention may be practiced without these specific details. In some instances, well-known structures and devices are shown in functional or conceptual diagram form in order to avoid obscuring the concepts of the presently disclosed extracting surface composition for a vehicle safety system.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention describes extracting surface composition for a vehicle safety system, it is to be further understood that numerous changes may arise in the details of the embodiments of extracting surface composition for a vehicle safety system. It is contemplated that all such changes and additional embodiments are within the spirit and true scope of this invention.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the invention and are not intended to limit the scope of the invention.

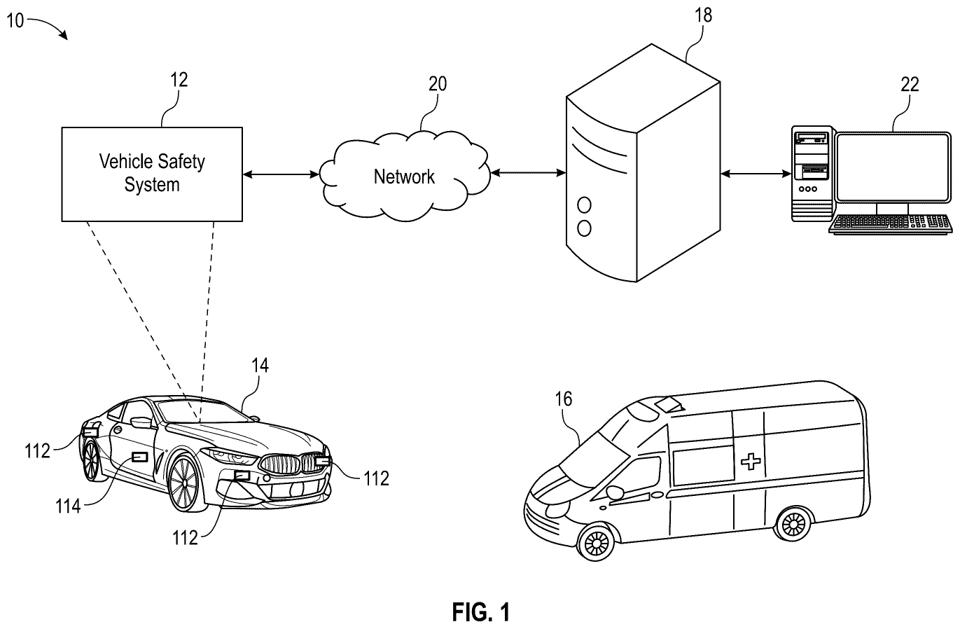

Various features and embodiments of a vehicle safety system are explained in conjunction with the description of FIGS. 1-4.

FIG. 1 shows an environment 10 in which a vehicle safety system 12 implements, in accordance with one embodiment of the present invention. Vehicle safety system 12 is positioned in a vehicle 14. In one example, vehicle safety system 12 comes in the form of an electronic device (not shown) such as a mobile phone, personal assistance device, a dedicated portable device, etc. In one example, vehicle safety system 12 integrates with a dashboard (not shown) of vehicle 14. In one example, vehicle safety system 12 comes as a standalone device that communicatively connects to the dashboard of vehicle 14. Vehicle 14 includes an emergency vehicle or non-emergency vehicle or both. An example of the emergency vehicle includes, but not limited to, an ambulance, fire truck, police vehicle, rescue vehicle, tow truck, etc. An example of the non-emergency vehicle includes, but not limited to, a car, a bus, a truck, etc. In the present invention, vehicle 14 indicates a non-emergency vehicle. Vehicle safety system 12 is configured to detect hazardous situations on a road while vehicle 14 is in motion or stopped/parked. In one example, vehicle safety system 12 is configured to detect hazardous situations i.e., emergency vehicles 16 on the road that are responding to an urgent situation and providing assistance to vehicles present on the road i.e., in the vicinity of vehicle 14. Optionally, vehicle safety system 12 is configured to alert a driver of vehicle 12 of another vehicle or emergency vehicle 16 on road. For ease of reference, vehicle 14 incorporating vehicle safety system 12 is referred to as a first vehicle 14, and emergency vehicles or another vehicle 16 on road is referred to as a second vehicle 16 hereinafter. Further, second vehicle 16 and emergency vehicle 16 are interchangeably used in the subsequent part of the description.

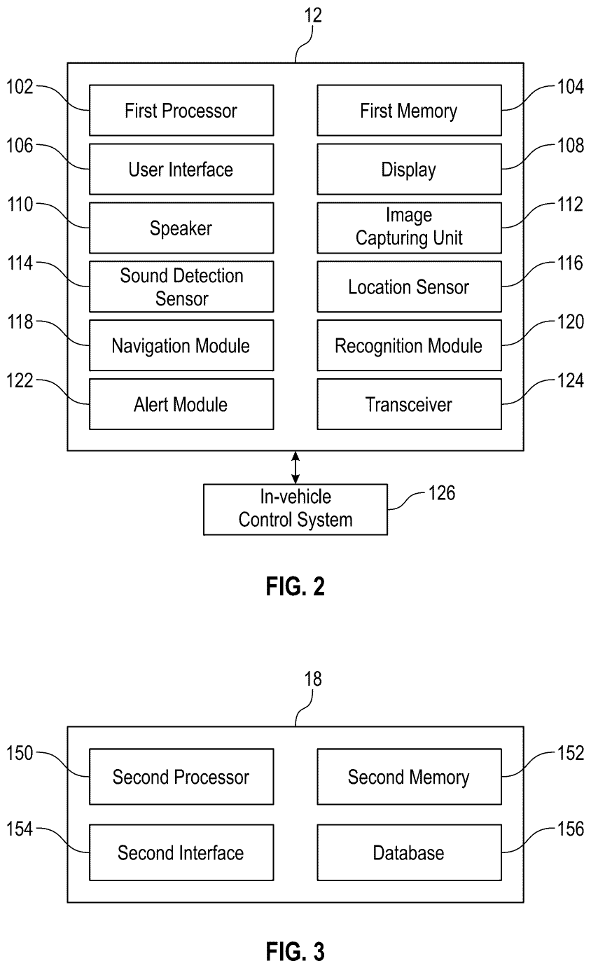

FIG. 2 shows a block diagram of vehicle safety system 12, in accordance with one embodiment of the present invention. Vehicle safety system 12 includes a first processor 102. First processor 102 includes a central processing unit (CPU), a graphics processing unit (GPU) or both. First processor 102 electrically couples a first memory 104 via a data bus (not shown). First memory 104 includes a volatile memory and/or a non-volatile memory. Preferably, first memory 104 stores instructions or software programs that interact with other devices such as a server 18, in-vehicle control system 126, etc. In one implementation, first processor 102 executes the instructions stored in first memory 104 in any suitable manner. In one implementation, first memory 104 stores digital data indicative of documents, files, programs, web pages, etc. retrieved from one of server 18, in-vehicle control system 126 and other devices.

Vehicle safety system 12 further includes a user interface (UI) 106 to operate vehicle safety system 12. Vehicle safety system 12 includes a display 108 (e.g., a liquid crystal display (LCD) or a cathode ray tube (CRT)). Further, vehicle safety system 12 includes a speaker or audio output device 110 for announcing text or voice instructions processed by first processor 102. Vehicle safety system 12 includes one or more image capturing units or cameras 112. Image capturing units 112 are mounted at the front, rear or sides or any other position on first vehicle 14, as shown in FIG. 1, for example. In one example, image capturing unit 112 includes a backup camera mounted to a rear of first vehicle 14. In another example, image capturing unit 112 includes one or more side cameras mounted on a side of first vehicle 14. In one example, image capturing unit 112 includes one or more front-facing cameras mounted on a front of first vehicle 14. In some embodiments, image capturing unit 112 includes an electronic sensor mounted on all sides of first vehicle 14 in multiple locations at multiple heights to visualize or identify visual/light notifications emitted from second vehicles 16. In one example, image capturing unit 112 is configured to detect a light source from second vehicle 16. In another example, image capturing unit 112 is configured to determine the flashing pattern of the light source from second vehicle 16. The images or light detected by image capturing unit 112 helps first processor 102 to process the information and determine whether second vehicle 16 is an emergency vehicle or another non-emergency vehicle.

Further, vehicle safety system 12 includes a sound detection sensor 114. Sound detection sensor 114 indicates a microphone or an audio sensor that is externally or internally mounted on first vehicle 14. In the present invention, sound detection sensor 114 is configured to detect sounds indicative of siren sources from second vehicle 16. Detection of the siren sources includes capturing audio signals from sound detection sensor 114 and processing the audio signals by first processor 102 to determine associated parameters. In one example, first processor 102 processes the audio signals by listening to energy in a 3 kHz region of an audio band. The energy at 3 kHz is generally associated with sirens used by emergency vehicles i.e., second vehicle 16. In other words, the energy at 3 kHz is not associated with commonly-experienced environmental sounds or non-emergency vehicles. As such, sound detection sensor 114 detects the presence of energy in the 3 kHz region to indicate to first processor 102 that a siren is detected. Optionally, sound detection sensor 114 detects the presence of energy having at least a threshold amplitude or other parameter to indicate to first processor 102 that a siren is detected. Optionally, sound detection sensor 114 detects siren sources when the sound transitions from no sound at a given frequency or sound below or above a threshold amplitude at the given frequency to any sound. Optionally, first processor 102 detects presence of a siren when the audio signals match with pre-stored siren sounds.

Vehicle safety system 12 includes a location sensor 116. Location sensor 116 includes a global positioning system (GPS) sensor configured to determine location of first vehicle 14. Further, vehicle safety system 12 includes a navigational module 118. Navigational module 118 includes an inertial navigation system that determines a position, orientation, and velocity/speed of first vehicle 14 using motion and rotation sensor inputs (not shown). Optionally, vehicle safety system 12 includes a recognition module 120. Recognition module 120 is configured to detect the type of second vehicle 16 based on the shape and size of second vehicle 16. Here, recognition module 120 compares the images captured by image capturing unit 112 and determines the type of second vehicle 16 by comparing them with pre-stored images, for example.

Vehicle safety system 12 includes an alert module 122. Alert module 122 is configured to trigger a visual alert on display 108 or an audio alert on speaker 110 when first processor 102 determines presence of second vehicle 16 or hazardous situation in the surroundings of first vehicle 14. Further, vehicle safety system 12 includes a transceiver 124. Transceiver 124 transmits or receives the instructions over a network 20 utilizing any one of a number of well-known transfer protocols.

In one implementation, vehicle safety system 12 communicatively connects to in-vehicle control system 126. In-vehicle control system 126 indicates a vehicle control unit, dashboard, and associated sensors/components such as a Powertrain Control (PTC), steering wheel, windows, doors, throttle (required power), brake including service brake, engine brake or regenerative braking, accessory control, etc., for operating first vehicle 14.

Vehicle safety system 12 communicatively connects to a server 18 via network 20. Server 18 is operated by a governmental agency or a service provider. FIG. 3 shows a block diagram of server 18, in accordance with one embodiment of the present invention. Server 18 includes a second processor 150, a second memory 152, a second interface 154 and a database 156. Second processor 150 electrically couples second memory 152. Second memory 152 includes a volatile memory and/or a non-volatile memory. Preferably, second memory 152 stores instructions or software programs that interact with other devices such as vehicles 14, 16 and a law enforcement device 22, etc. In one implementation, second processor 150 executes the instructions stored in second memory 152 in any suitable manner. In one implementation, second memory 152 stores digital data indicative of documents, files, programs, web pages, etc. retrieved from one of vehicles 14, 16 and law enforcement device 22 and other devices. Database 156 stores information corresponding to first vehicle 14, second vehicle 16, etc.

Network 20 includes a wireless network, a wired network or a combination thereof. Network 20 can be implemented as one of the different types of networks, such as intranet, local area network (LAN), wide area network (WAN), the internet, and the like. Network 20 implements as a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 20 includes a variety of network devices, including routers, bridges, servers, computing devices, storage devices, and the like.

Law enforcement device 22 indicates an electronic device such as a mobile device, a personal digital assistant, a laptop computer, a tablet computer, a desktop computer, etc. Law enforcement personnel e.g., a police officer or hospital staff operates law enforcement device 22.

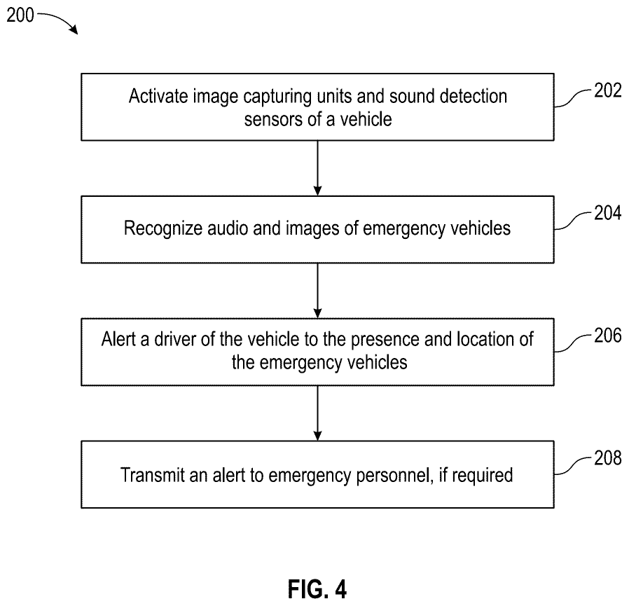

FIG. 4 shows a method 200 of alerting a driver of first vehicle 14 of hazardous situations, in accordance with one exemplary embodiment of the present invention. The order in which method 200 is described should not be construed as a limitation, and any number of the described method blocks can be combined in any order to implement method 200 or alternate methods. Additionally, individual blocks may be deleted from method 200 without departing from the spirit and scope of the invention described herein. Furthermore, method 200 can be implemented in any suitable hardware, software, firmware, or combination thereof. However, for ease of explanation, in the embodiments described below, method 200 may be implemented using the above-described vehicle safety system 12.

At step 202, vehicle safety system 12 activates each of image capturing units 112 and sound detection sensors 114. After activating, each of image capturing units 112 and sound detection sensors 114 is configured to recognize images of surrounding second vehicles 16 and audio signals for sirens indicating presence of emergency vehicles and/or hazardous situations, respectively, as shown at step 204. Vehicle safety system 12 processes light emitted by second vehicles 16 in order to determine them to be emergency vehicles. In one example, image capturing units 112 capture light of emergency vehicles 16 based on the color, flash pattern, and/or combination thereof. The light is captured using strobes, flash bars, light-emitting diodes (LEDs), incandescent, and other visible light equipment. In some examples, image capturing units 112 capture light of emergency vehicles 16 using strobes, flash bars, LEDs, incandescent, and other types of equipment that emit all spectrums of light not visible to the human eye, including infrared and ultraviolet light. In some embodiments, image capturing units 112 capture light of emergency vehicles 16 indicated by color, flash pattern, and/or combination of any or all of the above using strobes, flash bars, LEDs, incandescent, and any other equipment emitting light. In some embodiments, image capturing units 112 detect lights to activate traffic signal interruption systems.

In one example, image capturing units 112 detect flashing or blinking of lights in any fashion on railroad crossing indicators installed at railway grades. In one example, image capturing units 112 detect flashing or blinking lights on school buses (second vehicle 16) in amber or red as activated by the bus operator for the loading or unloading of passengers. In one example, image capturing units 112 detect flashing strobe lights on the roof of school buses that operate while the vehicle is in use. In one example, image capturing units 112 detect repeating pattern of lights and enter into an alert mode. In one example, image capturing units 112 detect flashing or blinking lights on any non-emergency vehicle also known as “hazard four-way Bashers.” In one example, image capturing units 112 detect a lighting system on any wrecker service vehicle. When the lighting system on any wrecker service vehicle is detected, then vehicle safety system 12 labels that as non-emergency vehicle and does not transmit signal to first processor 102. In one example, image capturing units 112 detect rain through visual indication. Optionally, first processor 102 utilizes other sensors or components such as windshield wipers to determine rain.

Concurrently or consecutively, vehicle safety system 12 employs sound detection sensor 114 to detect/recognize sounds produced by emergency vehicle 16. In one example, sound detection sensor 114 detects electronic and mechanical sirens, horns, and other sounds designed to call attention from others. In another example, sound detection sensor 114 detects the presence of energy in the 3 kHz region and/or the presence of energy having at least a threshold amplitude or other parameter to indicate to first processor 102 that a siren of emergency vehicle 16 is detected. Optionally, sound detection sensor 114 detects siren sources when the sound transitions from no sound at a given frequency or sound below or above a threshold amplitude at the given frequency to any sound to indicate the presence of emergency vehicle 16. Optionally, first processor 102 detects presence of siren of emergency vehicle 16 when the audio signals match with pre-stored siren sounds.

Further, sound detection sensor 114 is configured to recognize persistent sounding (honking) of the same horn in repeated or random fashion lasting longer than an adjustable time. Such a horn can be determined to be from any standard non-emergency vehicle. Optionally, sound detection sensor 114 is configured to recognize the sound of a gunshot, the blowout, screeching metal, sound of screeching tires, crashes, human screaming, human yelling, or other non-musical sounds. Similarly, sound detection sensor 114 is configured to recognize the sound of train horns, train whistles, and the crossing bells of train crossings.

After recognizing emergency vehicle 16 from the data received from image capturing unit 112 and/or sound detection sensor 114, first processor 102 analyses the information and determines a type of alert, a direction from which the alert originates and suggests action for a driver of first vehicle 14. At step 206, first processor 102 alerts the driver and/or passengers of first vehicle 14 to the presence/location of emergency vehicle 16. In one embodiment, first processor 102 employs alert module 122 to generate a notification/alert message. The alert message includes, but not limited to, live feed from image capturing unit 112 showing emergency vehicle 16, audible advisory to the driver to give way for emergency vehicle 16, direction or location of emergency vehicle 16, etc. In one example, alert module 122 employs display 108 to show text or video/images of emergency vehicle 16 to draw attention of the driver. In some examples, alert module 122 employs display 108 to show complete description of the alert, including the type of alert, the color of the lights causing the alert, a replay of the sound of the alert, the direction of the alert, and suggested action to the driver.

Optionally, alert module 122 employs speaker 110 to announce the alert at a high frequency/volume to draw attention of the driver of first vehicle 14 to emergency vehicle 16. Speaker 110 is employed to provide audible alerts to make the driver and passenger of first vehicle 14 aware of the danger/presence of emergency vehicle 16 in the vicinity/road. Examples of the audible alerts include, but not limited to, “Emergency vehicles ahead”, “Emergency vehicles behind”, “Emergency vehicles approaching from the left” (or right), “Vehicle with flashers activated ahead,”, “Train approaching ahead”, “School bus head”, etc. Alert module 122 generates the alert for a predetermined time period or until siren sound is no longer heard or until emergency vehicle 16 is not in field of view of image capturing unit 112.

In some embodiments, vehicle safety system 12 operates in conjunction with in-vehicle control system 126 to lower and/or turn off an entertainment (audio/video) system of first vehicle 14 to allow the driver to hear emergency sounds (user-selectable). Here, vehicle safety system 12 amplifies the exterior sound via speaker 110, if sound was the trigger, and plays the live sound through the entertainment system coming from the direction of the original sound. For instance, consider the siren sounds approaching from the right, then vehicle safety system 12 activates speakers 110 on the right to play the live sound.

In some embodiments, vehicle safety system 12 operates in conjunction with in-vehicle control system 126 to operate one or more windows on first vehicle 14 to the desired position/height to allow the driver and/or passenger to hear sounds from the emergency vehicle 16. In one example, vehicle safety system 12 raises the windows in case of a rain or change in environment.

Vehicle safety system 12 stores the data corresponding to alerts generated in first memory 104. The data stored includes, but not limited to, images/videos of surroundings i.e., emergency vehicle 16 or any hazardous situation, audio alerts generated, etc. Additionally, vehicle safety system 12 fetches location data from location sensor 116 and stores in first memory 104. Optionally, vehicle safety system 12 fetches speed data navigation module 118 and stores in first memory 104.

At step 208, vehicle safety system 12 transmits the data including the alerts to emergency personnel or law enforcement officers i.e., to law enforcement device 22, for later use, say as evidence.

In some implementations, vehicle safety system 12 utilizes an artificial intelligence to analyze the data captured by image capturing units 112 and/or sound detection sensor 114. For example, vehicle safety system 12 may process the data to determine the details of the hazard's location, speed, type of hazard, level of danger, proximity to the vehicle-containing system, and other relevant data. As specified above, vehicle safety system 12 integrates location sensor 116. Vehicle safety system 12 transmits the location details of first vehicle 14 to be used in hazard analysis.

In some implementations, vehicle safety system 12 may broadcast the alerts generated to nearby vehicles that may or may not have vehicle safety system 12 installed. Here, the other nearby vehicles includes transceivers (not shown) for receiving alerts from vehicle safety system 12 of first vehicle 14. In such implementations, first vehicle 14 includes an optional vehicle transmitter/emitter (not shown, or utilizes transceiver 124) to alert nearby vehicles of the impending hazard even if the other nearby vehicles having vehicle safety system 12 does not detect such. Here, other nearby vehicles that do not have vehicle safety system 12 may include a receiver (not shown) to receive alerts from vehicle safety system 12 of first vehicle 14. In some example, the alerts containing information regarding the hazard are transmitted to electronic devices (not shown) present in the nearby vehicles.

In one example, consider that first vehicle 14 has a cruise control system enabled. Here, first vehicle 14 having vehicle safety system 12 can respond to the hazard by temporarily disabling the cruise control system to allow first vehicle 14 to slow without acceleration.

Vehicle safety system 12 can be programmed by a user to determine how first vehicle 14 needs to respond to hazard detection. Optionally, vehicle safety system 12 is trained through user interaction if a detection was correct in the interpretation or if vehicle safety system 12 needs to relearn with new input from the user.

The presently disclosed vehicle safety system provides several advantages over prior art. For example, the vehicle safety system integrates with a first vehicle and provides advanced warning of emergency vehicles with activated emergency lights that a driver has not yet seen/heard using sensors (image capturing unit and/or sound detection sensor (microphone)) provided in the first vehicle. Upon detection, the vehicle safety system provides visual and/or audio alerts indicating the location of the emergency vehicle and/or course of action responsive to the emergency vehicle. This helps the driver to move away from the emergency vehicle in time and avoid slowing down the response to the emergency or a traffic incident. Further, the vehicle safety system helps the driver of the first vehicle to comply with regulations requiring yielding to emergency vehicles and stopping for school buses/trains, and enhances the safety of the driver of the first vehicle and of the others.

The vehicle safety system protects the occupants of the vehicle equipped and those in nearby vehicles. Further, the vehicle safety system protects first responders, bus drivers and occupants, train engineers and staff, innocent pedestrians in the area and innocent persons involved in vehicle accidents. The vehicle safety system helps to analyze sounds, lights, movement, flashing patterns of light, unusual sounds environmental sounds and other input data often not available to operators of today's vehicles to alert them of danger or hazards. The vehicle safety system demands the attention of the driver and any and all other occupants of the vehicle by turning off electronic entertainment (radios, streaming, video, etc.) lowering windows to better hear hazards, turning off heating, ventilation, and air conditioning (HVAC) systems for better hearing, an audible voice to explain the detected hazard and activate hazard flashers.

A person skilled in the art appreciates that the vehicle safety system may come in a variety of shapes and sizes depending on the need and comfort of the user. Further, many changes in the design and placement of components may take place without deviating from the scope of the presently disclosed vehicle safety system.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

I claim:

1. A vehicle safety system, comprising:
one or more sensors configured to detect light sources and light patterns, and/or audio signals indicative of presence of an emergency vehicle attending to a hazardous situation in proximity to a vehicle;
a processor configured to analyze data from said one or more sensors to determine a presence of said emergency vehicle in proximity to said vehicle; and
an alert module operatively connected to said processor, wherein said alert module provides an alert to an occupant of said vehicle when said processor determines the presence of said emergency vehicle.

2. The vehicle safety system of claim 1, wherein said one or more sensors comprises an image capturing unit and a sound detection sensor, wherein said image capturing unit detects light sources and light patterns emitted by said emergency vehicle, and wherein said sound detection sensor detects audio signals indicative of sirens emitted from said emergency vehicle.

3. The vehicle safety system of claim 1, further comprises a location sensor, wherein said location sensor determines a location of said vehicle.

4. The vehicle safety system of claim 3, wherein said processor analyses the data based on one of the location, speed of said emergency vehicle, type of said emergency vehicle, and the proximity of said emergency vehicle to said vehicle.

5. The vehicle safety system of claim 1, further comprises a transceiver, wherein said transceiver transmits said alert to at least one of a server, a law enforcement device, and nearby vehicles.

6. The vehicle safety system of claim 1, wherein said processor communicatively connects to an in-vehicle control system to:
lower volume or turn off an entertainment system of said vehicle; or
lower one or more windows of said vehicle; or
disable a cruise control system of said vehicle.

7. The vehicle safety system of claim 1, wherein said alert comprises a visual alert and/or an audio alert, wherein said vehicle safety system comprises a display and/or a speaker, and wherein said alert module provides said visual alert on said display or said audio alert on said speaker.

8. The vehicle safety system of claim 1, wherein said processor determines a direction from which said emergency vehicle is approaching.

9. The vehicle safety system of claim 1, further comprises a recognition module, wherein said recognition module determines a type of said emergency vehicle based on a shape and size of said emergency vehicle.

10. A vehicle safety system, comprising:
an image capturing unit configured to detect light sources and light patterns emitted by an emergency vehicle attending to a hazardous situation in proximity to a vehicle;
a sound detection sensor configured to detect audio signals indicative of sirens emitted from said emergency vehicle;
a location sensor configured to determine a location of said vehicle;
a processor configured to analyze data from said image capturing unit, said sound detection sensor, and said location sensor to determine a presence of said emergency vehicle in proximity to said vehicle, and determine a direction from which said emergency vehicle is approaching; and
an alert module operatively connected to said processor, wherein said alert module provides an alert to an occupant of said vehicle when said processor determines the presence of said emergency vehicle.

11. The vehicle safety system of claim 10, wherein said processor analyses the data based on one of the location, speed of said emergency vehicle, type of said emergency vehicle, and the proximity of said emergency vehicle to said vehicle.

12. The vehicle safety system of claim 10, further comprises a transceiver, wherein said transceiver transmits said alert to at least one of a server, a law enforcement device, and nearby vehicles.

13. The vehicle safety system of claim 10, wherein said processor communicatively connects to an in-vehicle control system to:
lower volume or turn off an entertainment system of said vehicle; or
lower one or more windows of said vehicle; or
disable a cruise control system of said vehicle.

14. The vehicle safety system of claim 10, wherein said alert comprises a visual alert and/or an audio alert, wherein said vehicle safety system comprises a display and/or a speaker, and wherein said alert module provides said visual alert on said display or said audio alert on said speaker.

15. The vehicle safety system of claim 10, further comprises a recognition module, wherein said recognition module determines a type of said emergency vehicle based on shape and size of said emergency vehicle.

16. A method of operating a vehicle safety system for alerting vehicle occupants of hazardous situations, said method comprising the steps of:
providing one or more sensors for detecting light sources and light patterns, and/or audio signals indicative of presence of an emergency vehicle attending to a hazardous situation in proximity to a vehicle;
analyzing data from said one or more sensors for determining a presence of said emergency vehicle in proximity to said vehicle; and
providing an alert to an occupant of said vehicle upon determining the presence of said emergency vehicle.

17. The method of claim 16, further comprising:
lowering volume or turning off an entertainment system of said vehicle; or
lowering one or more windows of said vehicle; or
disabling a cruise control system of said vehicle.

18. The method of claim 16, wherein said one or more sensors comprising an image capturing unit and a sound detection sensor, said image capturing unit detecting light sources and light patterns emitted by said emergency vehicle, and said sound detection sensor detecting audio signals indicative of sirens emitted from said emergency vehicle.

19. The method of claim 16, further comprising transmitting said alert to at least one of a server, a law enforcement device, and nearby vehicles.

20. The method of claim 16, further comprising determining a type of said emergency vehicle based on a shape and size of said emergency vehicle.
